(19) United States
(12) Patent Application Publication
(10) Pub. No.: US 2013/0240713 A1
(43) Pub. Date: Sep. 19, 2013

(54) PHOTOELECTRIC CONVERSION APPARATUS

(71) Applicant: CANON KABUSHIKI KAISHA, Tokyo (JP)

(72) Inventor: Kouji Maeda, Kawanishi-shi (JP)

(73) Assignee: CANON KABUSHIKI KAISHA, Tokyo (JP)

(21) Appl. No.: 13/787,451

(22) Filed: Mar. 6, 2013

(30) Foreign Application Priority Data
Mar. 19, 2012 (JP) 2012-062484

(51) Int. Cl. H04N 5/378

(52) U.S. Cl. CPC H04N 5/378
USPC 250/208.1

(57) ABSTRACT

A photoelectric conversion apparatus includes: a plurality of pixels (101) configured to output a signal according to incident light; a maximum value detecting unit (104) configured to input the signals output from the plurality of pixels, and to output a maximum value among the signals output from the plurality of pixels, based on a first reference voltage, through a plurality of common drain NMOS transistors; and a minimum value detecting unit (105) configured to input the signals output from the plurality of pixels, and to output a minimum value among the signals output from the plurality of pixels, based on a second reference voltage, through a plurality of common drain PMOS transistors.

### BACKGROUND OF THE INVENTION

1. Field of the Invention

The present invention relates to a photoelectric conversion apparatus.

2. Description of the Related Art

A photoelectric conversion apparatus is known that has a function of detecting the maximum value and the minimum value of a plurality of pixels, as an auto focusing sensor (hereinafter referred to as AF sensor) which is used in a camera. Such a technique has been described in Japanese Patent Application Laid-Open No. 2000-180706 as to output the maximum value or the minimum value in one row by simultaneously connecting voltage followers for one row to an output line, in a configuration in which each pixel in one row is connected to the output line through the respective voltage followers.

In the field of AF sensors, the voltage of a power source is becoming lower in order to reduce power consumption. Along with the trend, there are problems that an operation voltage range of a circuit is narrowed, and a dynamic range of a signal is also narrowed. Particularly, a circuit of a maximum value detecting instrument and a minimum value detecting instrument to output the values adopts a form of a common drain amplifying circuit, which narrows each of the operation voltage ranges by a difference between a ground potential or a power source voltage and a threshold voltage of a transistor, and accordingly the dynamic range results in being remarkably narrowed by the trend of the power source voltage to be lowered.

### SUMMARY OF THE INVENTION

According to an aspect of the present invention, a photoelectric conversion apparatus comprises: a plurality of pixels configured to output signal according to an incident light; a maximum value detecting unit configured to input the signals outputted from the plurality of pixels, and to output a maximum value among the signals outputted from the plurality of pixels, based on a first reference voltage, through a plurality of common-drain NMOS transistors; and a minimum value detecting unit configured to input the signals outputted from the plurality of pixels, and to output a minimum value among the signals outputted from the plurality of pixels, based on a second reference voltage, through a plurality of common-drain PMOS transistors.

Further features of the present invention will become apparent from the following description of exemplary embodiments with reference to the attached drawings.

### BRIEF DESCRIPTION OF THE DRAWINGS

FIG. 1 is a circuit diagram illustrating a photoelectric conversion apparatus according to a first embodiment.

FIG. 2 is a timing chart for describing an operation of the photoelectric conversion apparatus according to the first embodiment.

FIGS. 3A, 3B and 3C are views for describing input and output characteristics of a peak circuit, a bottom circuit and a clamping unit.

FIG. 4 is a circuit diagram illustrating a photoelectric conversion apparatus according to a second embodiment.

FIG. 5 is a timing chart for describing an operation of the photoelectric conversion apparatus according to the second embodiment.

FIG. 6 is a circuit diagram illustrating a photoelectric conversion apparatus according to a third embodiment.

### DESCRIPTION OF THE EMBODIMENTS

Preferred embodiments of the present invention will now be described in detail in accordance with the accompanying drawings.

### First Embodiment

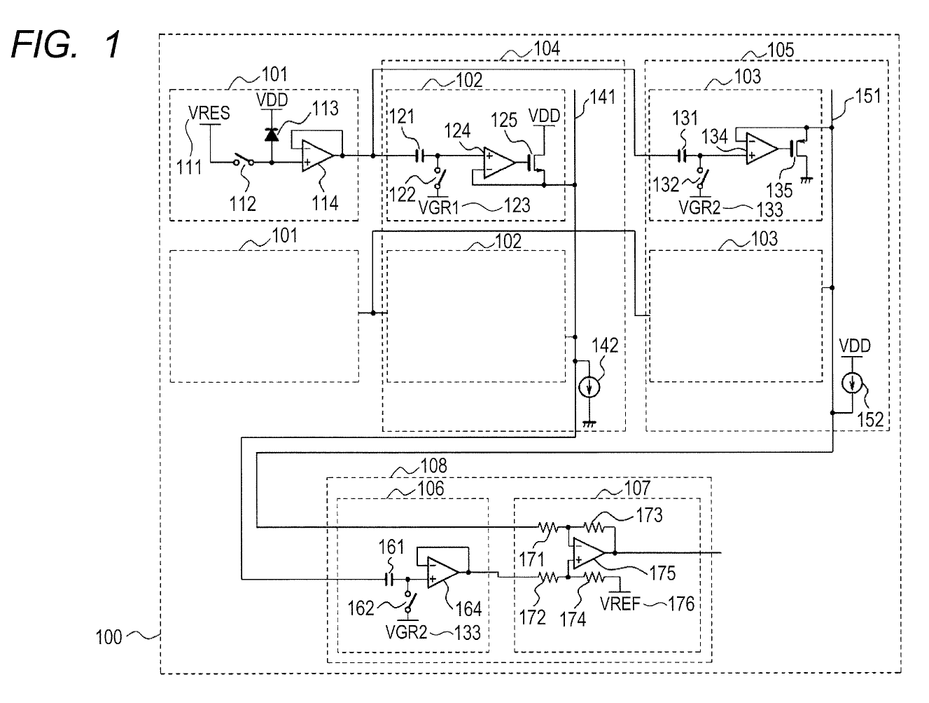

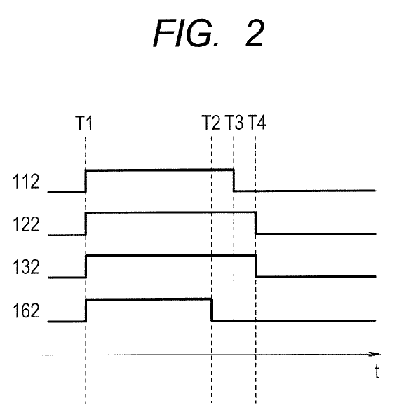

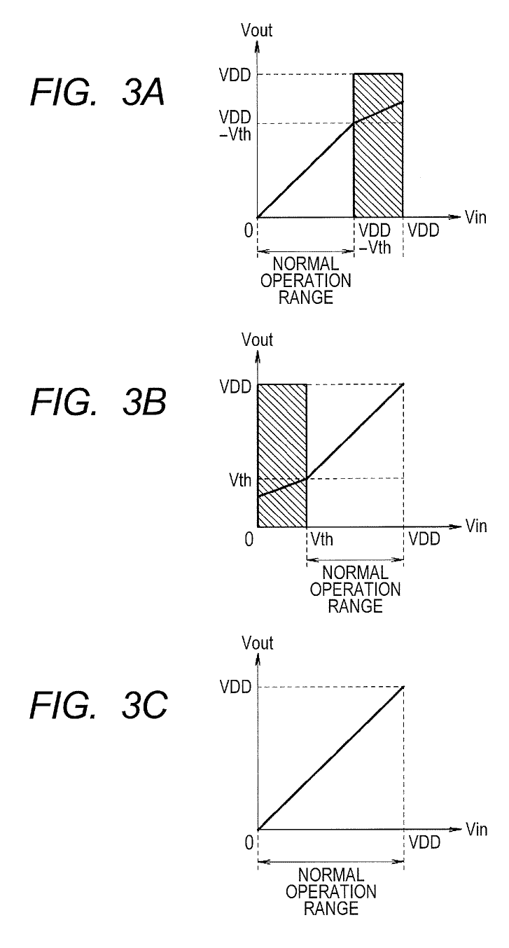

A photoelectric conversion apparatus according to a first embodiment of the present invention will be described below with reference to FIG. 1, FIG. 2 and FIGS. 3A to 3C. The photoelectric conversion apparatus 100 has a plurality of pixels 101, a maximum value detecting unit 104, a minimum value detecting unit 105, and an arithmetic circuit 108. Each of the plurality of the pixels 101 outputs a signal according to incident light. Each of the pixels 101 has a photoelectric conversion element 113 for generating an electric charge by photoelectric conversion according to the incident light, a reset switch 112, and a differential amplifier 114. The plurality of the pixels 101 are arrayed, for instance, in a linear manner. In the present embodiment, a cathode of a photodiode which is the photoelectric conversion element 113 is connected to a node of a power source potential VDD, and an anode thereof is connected to a reset potential (VRES) 111 through the reset switch 112 and is also connected to a non-inverting input terminal of the differential amplifier 114. Here, a circuit is illustrated in which the differential amplifier 114 is used as a voltage follower, but the differential amplifier 114 may be another type of amplifier such as a common drain circuit, for instance.

The maximum value detecting unit 104 has a plurality of peak circuits 102, a maximum output line 141, and a constant current source 142. An output node of the peak circuit 102 is connected to the maximum output line 141. The constant current source 142 has one terminal which is connected to a node of the ground potential, and the other terminal which is connected to the maximum output line 141. The peak circuit 102 has a clamp capacitor 121, a clamp switch 122, a node of a first reference voltage (VGR1) 123 (for instance, ground potential), a differential amplifier 124, and a common drain NMOS transistor 125. The clamp capacitor 121 has one terminal which is connected to the output node of the pixel 101, and the other terminal which is connected to the non-inverting input terminal of the differential amplifier 124, and to a node of the first reference voltage VGR1 through the clamp switch 122. The common drain NMOS transistor 125 has a drain terminal which is connected to a node of the power source potential VDD, has a gate terminal which is connected to an output terminal of the differential amplifier 124, and has a source terminal which is connected to an inverting input terminal of the differential amplifier 124, and to the maximum output line 141. The maximum value detecting unit 104 inputs signals output from the plurality of the pixels 101, and outputs the maximum value among the signals output from the plurality of the pixels 101, based on the first reference voltage VGR1, through the plurality of the common drain NMOS transistors 125. Specifically, the maximum value detecting unit 104 outputs the maximum value because the output nodes of the plurality of the common drain NMOS transistors 125 are connected to the maximum output line 141.

The minimum value detecting unit 105 has a plurality of bottom circuits 103, a minimum output line 151, and a constant current source 152. An output node of the bottom circuit 103 is connected to the minimum output line 151. The constant current source 152 has one terminal which is connected to a node of the power source potential VDD, and the other terminal which is connected to the minimum output line 151. The bottom circuit 103 has a clamp capacitor 131, a clamp switch 132, a node of a second reference voltage (VGR2) 133 (for instance, potential of a threshold voltage Vth or higher), a differential amplifier 134, and a common drain PMOS transistor 135. The clamp capacitor 131 has one terminal which is connected to the output node of the pixel 101, and the other terminal which is connected to a non-inverting input terminal of the differential amplifier 134, and to a node of the second reference voltage VGR2 through the clamp switch 132. The common drain PMOS transistor 135 has a drain terminal which is connected to a node of the ground potential, has a gate terminal which is connected to an output terminal of the differential amplifier 134, and has a source terminal which is connected to an inverting input terminal of the differential amplifier 134, and to the minimum output line 151. The minimum value detecting unit 105 inputs signals output from the plurality of the pixels 101, and outputs the minimum value among the signals output from the plurality of the pixels 101, based on the second reference voltage VGR2, through the plurality of the common drain PMOS transistors 135. Specifically, the minimum value detecting unit 105 outputs the minimum value because the output nodes of the plurality of the common drain PMOS transistors 135 are connected to the minimum output line 151.

The arithmetic circuit 108 has a clamping unit 106 and a differential amplifier circuit 107. The clamping unit 106 has a clamp capacitor 161, a clamp switch 162, and a node of the second reference voltage (VGR2) 133. The clamp capacitor 161 has one terminal which is connected to the maximum output line 141, and the other terminal which is connected to a node of the second reference voltage VGR2 through the clamp switch 162, and to a non-inverting input terminal of a differential amplifier 164. The differential amplifier circuit 107 has resistors 171, 172, 173 and 174, a differential amplifier 175, and a node of a reference voltage (VREF) 176 of an output of the differential amplifier circuit 107. The resistor 171 has one terminal which is connected to the minimum output line 151, and the other terminal which is connected to an inverting input terminal of the differential amplifier 175, and to an output terminal of the differential amplifier 175 through the resistor 173. The resistor 172 has one terminal which is connected to an output terminal and an inverting input terminal of the differential amplifier 164 contained in the clamping unit 106, and the other terminal which is connected to a non-inverting input terminal of the differential amplifier 175, and to a node of the reference voltage 176 for an output of the differential amplifier circuit 107 through the resistor 174.

Next, an operation of the photoelectric conversion apparatus 100 of FIG. 1 will be described below with reference to FIG. 2. In a timing chart of FIG. 2, control signals 112, 122, 132 and 162 are shown which are given to switches denoted by the same reference numerals of FIG. 1. Each of the switches is turned on when a control signal is a high level, in other words, becomes a conductive state, and each of the respective switches is turned off when the control signal is a low level, in other words, becomes a non-conductive state.

Firstly, at the time T1, the reset switch 112 and the clamp switches 122, 132 and 162 are turned on, and the anode of the photoelectric conversion element 113, in other words, the non-inverting input terminal of the differential amplifier 114 is reset by a reset potential 111. Signals output from the maximum output line 141 and the minimum output line 151 at this time become reference signals of the maximum value detecting unit 104 and the minimum value detecting unit 105, respectively.

Next, at the time T2, the clamp switch 162 is turned off, and a potential difference between the reference signal of the maximum value detecting unit 104 and the second reference voltage VGR2 is held by the clamp capacitor 161.

Next, at the time T3, the reset switch 112 is turned off. When the switch 112 is turned off, the anode potential of the photoelectric conversion element 113 varies from the reset potential 111 by charge injection, and charge accumulation starts. When the photoelectric conversion element 113 receives light, the anode potential of the photoelectric conversion element 113 rises due to the electric charge which has been generated by the photoelectric conversion of the photoelectric conversion element 113.

Next, at the time T4, the clamp switches 122 and 132 are turned off, and a potential difference between the potential output from the pixel 101 and the first reference voltage VGR1 is held by the clamp capacitor 121. In addition, a potential difference between the potential output from the pixel 101 and the second reference voltage VGR2 is held by the clamp capacitor 131. On this occasion, the potential output from the pixel 101 contains an amount of the variation of the potential due to the charge injection of the reset switch 112, and the amount of the variation of the potential can also be clamped. At the time T4, the non-inverting input terminals of the differential amplifiers 124 and 134 become a floating state at the reference voltage.

In the maximum value detecting unit 104, the common drain NMOS transistor 125 and the constant current source 142 constitute a common drain amplifying circuit.

Because all of the output nodes of the peak circuits 102 in one line are connected to the maximum output line 141 and the constant current source 142, only a common drain NMOS transistor 125 in the peak circuits 102 is turned on, which is connected to the pixel 101 having the highest potential among the signals of the pixel 101 in one line. Accordingly, the maximum value among the signals output from the pixels 101 in one line appears in the maximum output line 141. The photoelectric conversion apparatus 100 outputs the potential of the maximum output line 141 at this time as the maximum value, from the maximum value detecting unit 104.

In the minimum value detecting unit 105, the common drain PMOS transistor 135 and the constant current source 152 constitute the common drain amplifying circuit. Because all of the output nodes of the bottom circuits 103 in one line are connected to the minimum output line 151 and the constant current source 152, only a common drain PMOS transistor 135 in the bottom circuits 103 is turned on, which is connected to the pixel 101 having the lowest potential among the signals of the pixels 101 in one line. Accordingly, the minimum value among the signals output from the pixels 101 in one line appears in the minimum output line 151. The photoelectric conversion apparatus 100 outputs the potential of the minimum output line 151 at this time as the minimum value, from the minimum value detecting unit 105.

In the arithmetic circuit 108, an output of the maximum value detecting unit 104 is input into one terminal of the clamp capacitor 161, so as to equalize the reference voltages for the outputs from the maximum value detecting unit 104 and the minimum value detecting unit 105. A potential difference between the first reference voltage and the second reference voltage is already stored in the clamp capacitor 161, and accordingly the maximum value signal based on the second reference voltage is output to the other terminal of the clamp capacitor 162.

The differential amplifier circuit 107 inputs the maximum value and the minimum value based on the second reference voltage, amplifies a differential signal between the maximum value and the minimum value, and outputs the amplified differential signal with reference to the reference voltage 176.

Next, a dynamic range of the photoelectric conversion apparatus 100 will be described below with reference to FIGS. 3A to 3C. The threshold voltages of the NMOS transistor and the PMOS transistor contained in the photoelectric conversion apparatus 100 shall be both a threshold voltage Vth.

FIG. 3A is a view illustrating input and output characteristics of an output buffer circuit that includes the differential amplifier 124 and the common drain NMOS transistor 125 which are contained in the peak circuit 102. In order that this output buffer configuration normally operates, a potential difference of the threshold voltage Vth or higher is necessary between a gate and a source of the common drain NMOS transistor 125. Because the upper limit of a gate potential is the power source potential VDD, the upper limit of a potential output from the source results in being VDD-Vth. Because of this, a normal operation range results in being a range from the ground potential (0 V) up to the potential VDD-Vth.

FIG. 3B is a view illustrating input and output characteristics of an output buffer circuit that includes the differential amplifier 134 and the common drain PMOS transistor 135 which are contained in the bottom circuit 103. In order that this output buffer configuration normally operates, a potential difference of the threshold voltage Vth or higher is necessary between a gate and a source of the common drain PMOS transistor 135. Because the lower limit of the gate potential is the ground potential, the lower limit of a potential output from the source results in being Vth. Because of this, the normal operation range results in being a range from the threshold voltage Vth up to the power source potential VDD.

As in the above description, the normal operation range in FIG. 3A of the buffer circuit contained in the peak circuit 102 is different from the normal operation range in FIG. 3B of the buffer circuit contained in the bottom circuit 103. Then, the first reference voltage VGR1 contained in the peak circuit 102 is set at the ground potential, and the second reference voltage VGR2 contained in the bottom circuit 103 is set at Vth. Thereby, the respective dynamic ranges of the maximum value signal and the minimum value signal can be most widened. Thus, the first reference voltage VGR1 can be lower than the second reference voltage VGR2.

However, if the reference voltages for the maximum value signal and the minimum value signal are different from each other, it becomes difficult to calculate a differential signal in the differential amplifier circuit 107. In addition, when a gain is applied to the differential signal, the gain is also applied to the difference between the reference voltages, and the dynamic range of the signals output from the differential amplifier circuit 107 results in being narrowed. Because of this, it is desirable to eliminate the difference between the reference voltages, before the values are input into the differential amplifier circuit 107. Then, the clamping unit 106 clamps the first reference voltage to the second reference voltage, and thereby outputs the maximum value signal based on the second reference voltage. Thereby, the differential amplifier circuit 107 inputs the maximum value and the minimum value based on the second reference voltage, accordingly can amplify the differential signal between the maximum value and the minimum value based on the same reference voltage, and can output the amplified differential signal. The clamping unit 106 is a reference voltages controlling unit, inputs the maximum value of the maximum output line 141 and the minimum value of the minimum output line 151, and reduces the potential difference between the reference voltage for the maximum value and the reference voltage for the minimum value. The differential amplifier circuit 107 is a difference calculating unit, and calculates a difference between the maximum value and the minimum value in which the above described potential difference has been reduced.

FIG. 3C is a view illustrating input and output characteristics of a voltage buffer circuit that includes a differential amplifier 164 contained in a clamping unit 106. If the differential amplifier 164 is designed so as to form Rail-to-Rail, the input and output range results in being a range from the ground potential (0 V) up to the power source potential VDD. Because of this, the dynamic range of the maximum value and the minimum value after clamping can be widened.

In the present embodiment, the constant current sources 142 and 152 have been used as a load of driving the maximum output line 141 and the minimum output line 151, but a resistance load may be used in place of the constant current sources 142 and 152. The present embodiment has been described while taking the case where the reference voltages are equalized by clamping the first reference voltage VGR1 with the second reference voltage VGR2. Specifically, the clamping unit 106 clamps the reference voltage of the maximum value of the maximum output line 141 to the second reference voltage VGR2. However, the present embodiment is not limited to this case. For instance, such a method is considered as to clamp the second reference voltage VGR2 with the first reference voltage VGR1. The output node of the minimum value detecting instrument 105 is connected to one terminal of the clamp capacitor 161, and the node of the first reference voltage VGR1 is connected to the other terminal through a switch 162. Thereby, the minimum value signal may be output based on the first reference voltage VGR1. Specifically, the clamping unit 106 clamps the reference voltage of the minimum value of the minimum output line 151 to the first reference voltage VGR1. In this case as well, the reference voltages of the maximum value and the minimum value are equalized, and accordingly the differential amplifier circuit 107 can amplify the differential signal between the maximum value and the minimum value and can output the amplified differential signal.

### Second Embodiment

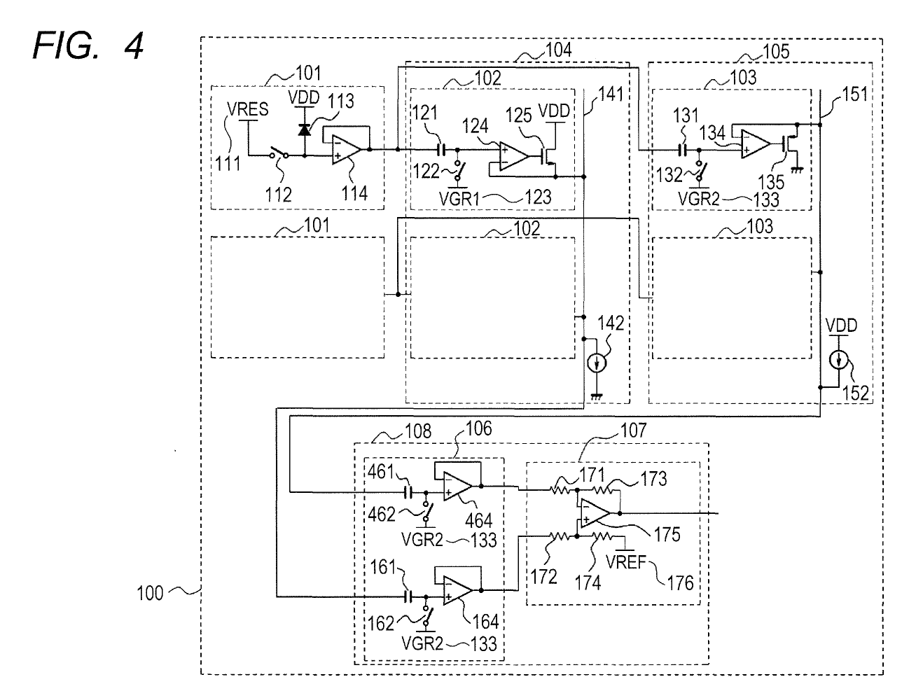

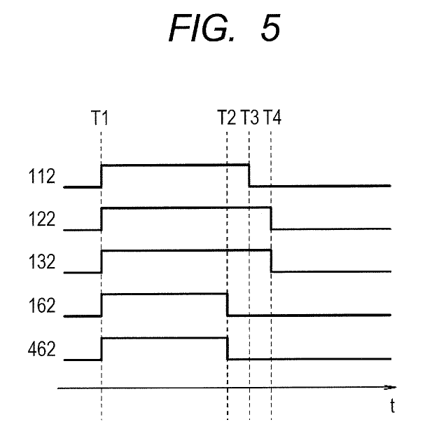

A photoelectric conversion apparatus according to a second embodiment of the present invention will be described below with reference to FIG. 4 and FIG. 5. A difference between the photoelectric conversion apparatus 100 of FIG. 4 and the photoelectric conversion apparatus 100 of FIG. 1 exists in a point that a clamp capacitor 461, a clamp switch 462 and a differential amplifier 464 have been added. In FIG. 4, the same components as those in FIG. are denoted by the same reference numerals, and accordingly points different from those in FIG. 1 will be described below. One terminal of the clamp capacitor 461 is connected to a minimum output line 151, and the other terminal is connected to a node of the second reference voltage VGR2 through the clamp switch 462, and to a non-inverting input terminal of the differential amplifier 464. An output terminal of the differential amplifier 464 is connected to the inverting input terminal and a resistor 171.

Next, an operation of the photoelectric conversion apparatus according to the second embodiment will be described below with reference to FIG. 5. A difference between the operation according to the present embodiment and the operation according to the first embodiment exists in a point that the switch 462 is added. A clamping unit 106 simultaneously turns the switch 462 and the switch 162 on/off, and thereby clamps a signal based on the second reference voltage VGR2 which is the reference signal of a minimum value detecting unit 105, with the second reference voltage VGR2.

An effect peculiar to the present embodiment is that the clamping unit 106 gives the variations of electric charges to be held by the clamp capacitors 161 and 461 due to charge injection occurring when the clamp switches 162 and 462 are turned off equally to both of the maximum value signal and the minimum value signal. Thereby, in the present embodiment, the differential signal between the maximum value and the minimum value can cancel an influence of the charge injection, and can accurately calculate the difference between the maximum value and the minimum value, compared to the configuration in the first embodiment.

### Third Embodiment

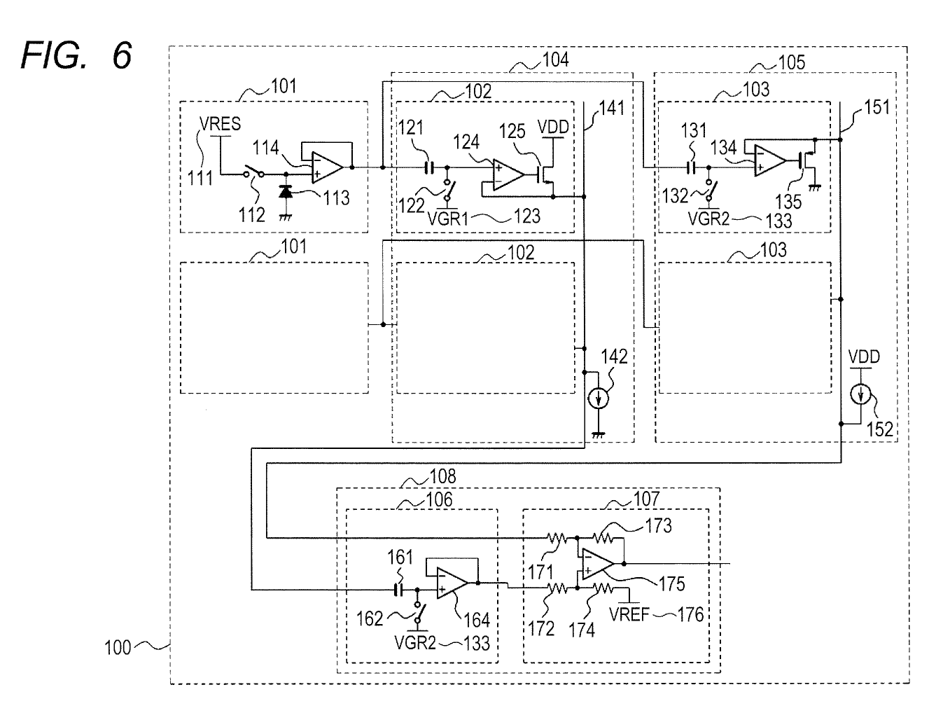

A photoelectric conversion apparatus according to a third embodiment of the present invention will be described below with reference to FIG. 6. In the photoelectric conversion apparatus 100 illustrated in FIG. 6, the same components as those in FIG. 1 are denoted by the same reference numerals, and accordingly points different from those in FIG. 1 will be described below. In the pixel 101 of FIG. 1, an anode of a photoelectric conversion element 113 has been connected to a non-inverting input terminal of the differential amplifier 114, but in the pixel 101 of FIG. 6, a cathode of the photoelectric conversion element 113 is connected to the non-inverting input terminal of the differential amplifier 114 and the anode is connected to a node of the ground potential. In this configuration, when the photoelectric conversion element 113 receives light, the potential of the non-inverting input terminal of the differential amplifier 114 is lowered. The first reference voltage VGR1 in the present embodiment is, for instance, a power source potential VDD, and the second reference voltage VGR2 has desirably a potential of VDD-Vth or lower. In this case, the first reference voltage VGR1 is higher than the second reference voltage VGR2.

The photoelectric conversion element 113 in FIG. 1 raises the potential by receiving light and collecting holes. The photoelectric conversion element 113 in FIG. 6 lowers the potential by receiving the light and collecting electrons. Generally, the mobility of the electron is 3 times as fast as that of the hole, and accordingly the responsiveness of the output of the pixel signal of the present embodiment becomes quicker than that in the first embodiment.

Note that the above embodiments are merely examples of how the present invention can be practiced, and the technical scope of the present invention should not be restrictedly interpreted by the embodiments. In other words, the present invention can be practiced in various ways without departing from the technical concept and main features of the invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-062484, filed Mar. 19, 2012, which is hereby incorporated by reference herein in its entirety.

What is claimed is:

1. A photoelectric conversion apparatus comprising:
a plurality of pixels configured to output signal according to an incident light;
a maximum value detecting unit configured to receive the signals outputted from the plurality of pixels, and to output a maximum value among the signals outputted from the plurality of pixels, based on a first reference voltage, through a plurality of common-drain NMOS transistors; and
a minimum value detecting unit configured to receive the signals outputted from the plurality of pixels, and to output a minimum value among the signals outputted from the plurality of pixels, based on a second reference voltage, through a plurality of common-drain PMOS transistors.

2. The photoelectric conversion apparatus according to claim 1,
further comprising:
a reference voltage controlling unit configured to receive the maximum value and the minimum value, and to control so as to reduce a difference between a reference voltage of the maximum value and a reference voltage of the minimum value; and
a difference calculating unit configured to calculate a difference between the maximum value and the minimum value after the difference between the reference voltage of the maximum value and the reference voltage of the minimum value is reduced.

3. The photoelectric conversion apparatus according to claim 2,
wherein
the reference voltage controlling unit includes a clamping unit configured to clamp the reference voltage of the maximum value to the second reference voltage.

4. The photoelectric conversion apparatus according to claim 2,
wherein
the reference voltage controlling unit includes a clamping unit configured to clamp the reference voltage of the minimum value to the first reference voltage.

5. The photoelectric conversion apparatus according to claim 1,
wherein
the maximum value detecting unit outputs the maximum value by connecting an output node of the plurality of common-drain NMOS transistors to a maximum output line.

6. The photoelectric conversion apparatus according to claim 1,
wherein
the minimum value detecting unit outputs the minimum value by connecting an output node of the plurality of common-drain PMOS transistors to a minimum output line.
